(19) United States
(12) Patent Application Publication
(10) Pub. No.: US 2014/0322094 A1
(43) Pub. Date: Oct. 30, 2014

(54) Noval synthesis method of long length Carbon Nanotube

(71) Applicants: Jian Wang, San Diego, CA (US); Alexandre Charapov, San Diego, CA (US)

(72) Inventors: Jian Wang, San Diego, CA (US); Alexandre Charapov, San Diego, CA (US)

(21) Appl. No.: 13/872,092

(22) Filed: Apr. 27, 2013

(51) Int. Cl. B01D 9/00

(52) U.S. Cl. CPC B01D 9/00; B01D 2009/0086
USPC 422/245.1

(57) ABSTRACT

Method and apparatus are presented for synthesis SWNT (single wall) or MWNT (multiple walls) of the carbon nanotube structure. According to the invention the very long length of the carbon tube can be synthesized in the spiral threaded holes of the rotating cylinders using the electromagnetic resonance phenomena.

### BACKGROUND OF THE INVENTION

1. Field of the Invention

The present disclosure relates to apparatus for synthesizing a carbon nanotube thread and, more particularly, to apparatus for synthesizing a single-wall or multi-wall carbon nanotube thread with mechanical electro-magnetic method.

2. Discussion of Related Art

Carbon nanotubes are very small tube-shaped structures having the composition of a graphite sheet, formed as a tube. The discovery of nanotubes was back to 1952, L. V. Radushkevich and V. M. Lukyanovich published clear images of 50 nanometer diameter tubes made of carbon in the Soviet Journal of Physical Chemistry. While Carbon nanotubes produced by arc discharge between graphite rods were first discovered and reported in an article by Sumio Iijima entitled “Helical Microtubules of Graphitic Carbon” (Nature, Vol. 354, Nov. 7, 1991, pp. 56-58). Now a days, techniques have been developed to produce nanotubes in sizable quantities, including arc discharge, laser ablation, high-pressure carbon monoxide disproportionation(HiPro) and chemical vapor deposition(CVD) [2]. But so far the longest carbontubes claimed is about 18.5 centimeters [2]. Due to the form of atomic vacancies, defects can occur, which can lower the tensile strength by up to 85%[2].

Due to the unique physical and electrical properties of nanotubes, this technology can be widely used in many fields.

However, it is difficult to synthesize a satisfying length of carbon nanotubes, as mentioned before, the known longest nanotube is about 18.5 cm.

What is needed, therefore, is to provide an apparatus for effectively synthesizing a single-wall or multi-wall carbon nanotube thread with desired length, and with reduced defects.

### SUMMARY OF THE INVENTION

It is an object of invention to provide technology for synthesing superior length of the SWNT and MWNT carbon nanotubes. Benzene (C6H6) is recommended as a most convenient raw material for this invented carbon nanotube synthesis process. The synthesized carbon nanotube generated with this innoval method has very high conductivity and tensile properties.

### BRIEF DESCRIPTION OF THE DRAWINGS

Many aspects of the present apparatus for synthesizing carbon nanotube with physical method can be better understood with reference to the following drawings. The components in the drawings are not necessarily to scale, the emphasis instead being placed upon clearly illustrating the principles of the present apparatus. Moreover, in the drawings, like reference numerals designate corresponding parts throughout the several views.

FIG. 1 is a side schematic view of an apparatus for synthesizing the carbon nanotube array in accordance with an embodiment.

FIG. 2 is a 3D schematic view for synthesizing carbon nanotube array.

FIG. 3 shows an outside schematic view of carbon nanotube array.

FIG. 4 is a set of 3 drawings to show electro-magnetic field generated, including separate views from solenoid wrapped on the non-rotating cylinder and from the nanotube due to its high conductivity, and finally a merged view of both.

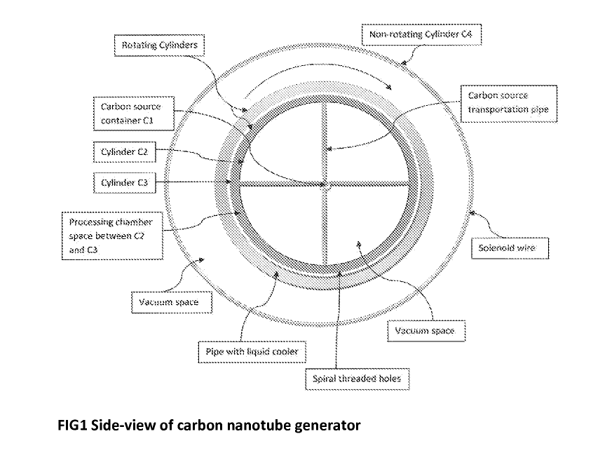

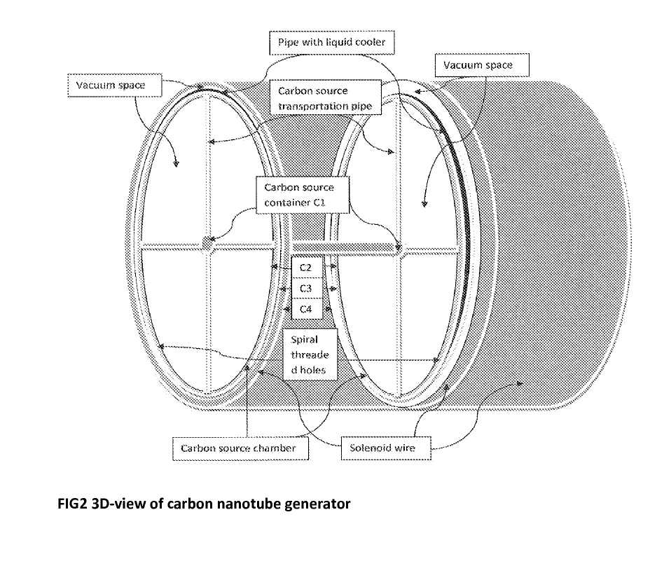

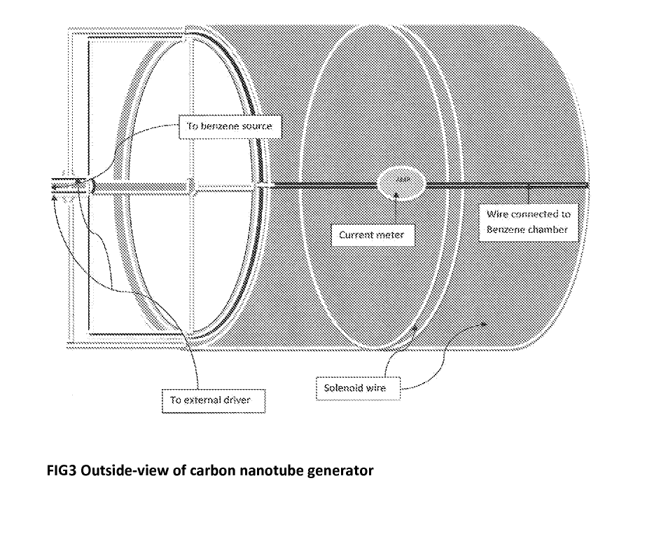

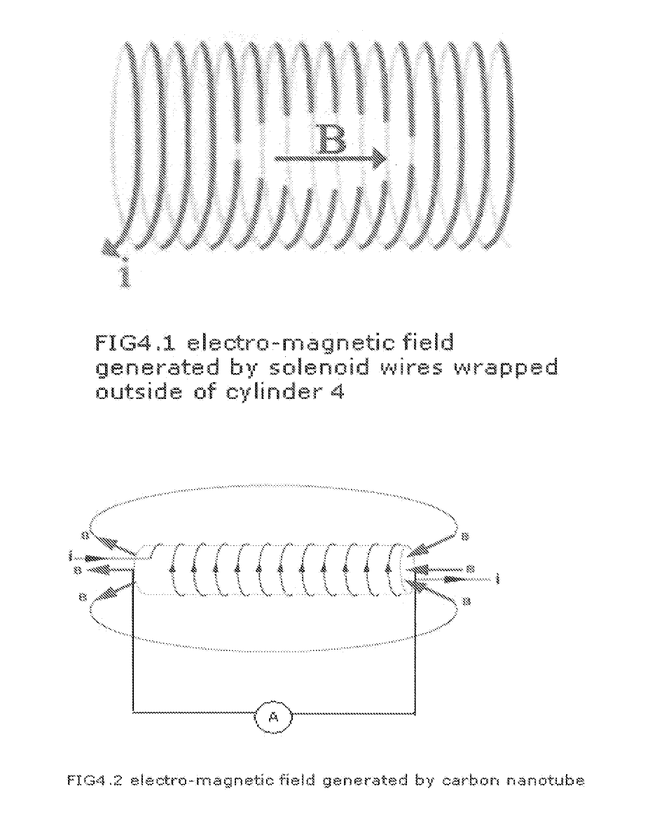

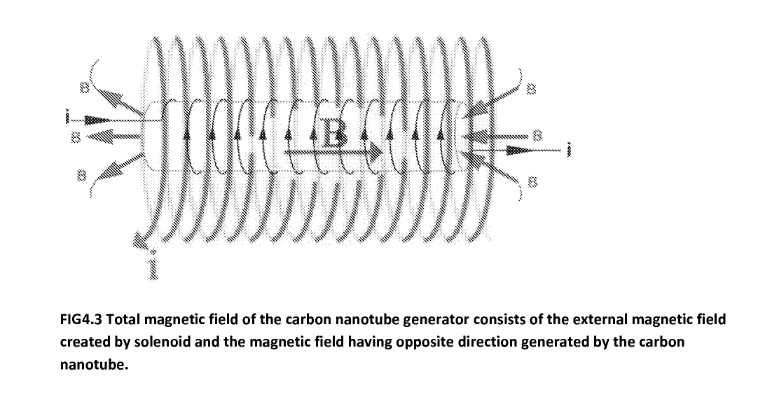

### DETAILED DESCRIPTION OF EMBODIMENTS

The apparatus to synthesize carbon nanotube thread is made of a set of cylinders rotating with an angle speed of 100 circles per second. The two cylinders forming synthesis chamber are built from glass (SiO2) or some other high quality solid insulators. The diameter of the external cylinder forming the external wall of the synthesis chamber is 1 meter. The diameter of the internal cylinder forming the internal wall of the synthesis chamber is 0.995 meters. Therefore the space between these two cylinders, as known as the width of the synthesis chamber, is 5 mm. The center of the above 2 cylinders is the container of the liquid carbon source. This container is a 0.1 m diameter cylinder. The carbon source container also consists of insulator and can be glass or polymer. There are a few pipes from the liquid carbon source container connected to the carbon nanotube synthesis chamber for liquid carbon source injection into the chamber, the number of the pipes can be 4, or 6, or 8, etc. The carbon source container rotates together with the synthesis chamber. The space between the container of the liquid source of the carbon (Benzene) and synthesis chamber must be vacuumed.

The external wall of the synthesis chamber engraved by spiral threaded holes wrapped around the wall. The threaded holes of the cylinder are like threaded holes on nuts. The threaded holes on the internal wall of the cylinder of the synthesis chamber are created by heating with the high power laser beam, whose diameter is from 10 nm to 100 nm, and inching process after that. The diameter of the threaded holes depends on the targeting nanotube radius. It could be from as small as 10 nm (10̂(−8) meters) up to 100 nm(10̂(−7) meters). The depth of the threaded holes has to be at least 1.5 times bigger than its diameter. The distance between neighbored threaded holes (the step of the threaded holes) should be 1.5 times or more than the diameter of the threaded hole. The outside of the synthesis chamber, e.g. the external wall of the cylinder, is wrapped around with cooling pipes. The material of the cooling pipes is polymer. The cooler is injected to the pipe before the cylinders start rotating. The purpose of the cooling pipe is to maintain inside of the synthesis chamber a constant temperature during the carbon nanotube synthesis process. Because the invention uses Benzene as a liquid source of carbon, the cooler can be just 5.5 C degree distilled water.

Outside of the cooling pipe is vacuumed space followed by the non-spinning fourth cylinder wrapped with solenoid wires. The purpose of this fourth cylinder is to isolate the rotating surface of the cylinders from the external world for safety purposes as well as to prevent the undesirable heating of the synthesis chamber.

The raw liquid source of the carbon nanotube (Benzene) injected to the synthesis chamber has to be completely penetrated inside of the threaded holes. No liquid Benzene (gaseous Benzene is allowed) is allowed outside of the threaded holes. The total amount of the Benzene can be calculated using next equation:

Total amount of the Benzene=Total amount of the gaseous Benzene+Total amount of liquid Benzene inside of the threaded hole

Where, the total amount of the gaseous Benzene equals density of the gaseous Benzene multiplied by the volume of the synthesis chamber. Total amount of the liquid Benzene equals density of the liquid Benzene multiplied by the half of volume of the threaded holes. The volume of the threaded hole equals total length multiplied by Pi=3.14 multiplied by the quarter of the diameter square of the threaded hole.

The ratio of the gaseous and liquid of Benzene can be controlled through the rotating speed of the synthesis chamber. If the speed rotation increases then the pressure in the synthesis chamber also increases and therefore liquid part of Benzene also increases.

The forth unmoved cylinder wrapped around with electrical (copper) wire creates classical solenoid. The solenoid is used to create alternating magnetic field inside of the rotating cylinders. The targeting magnitude of the magnetic field is about B=10 Tesla. The high alternating magnetic field is required to break the C—H atomic connection in Benzene carbon source. The C—H connection in Benzene can be represented as an electrical dipole, where H has positive charge and C has negative charge. To create resonance condition the external magnetic field (Fext.) has to have value multiple of the natural frequency (Fdipole) of the C—H dipole:

N*Fext.=Fdipole,

Where, N is an integer.

Because of the synthesis chamber rotation, the H+ atom will be separated from the Benzene molecule, and eventually two H+ atoms would meet and create molecular of hydrogen H2. After the C—H connection being broken, the unbalanced C— of C6H5 will connect with another unbalanced C6H5 C—. The new molecular would be created as C6H5—C6H5. The synthesis process continues until unbalanced C— ultimately being cleaned up and thus carbon nanotube is synthesized as a result.

A certain type of carbon nanotube is highly conductive. And the resistance of the carbon nanotube doesn't depends on the length and equals a few kΩ[3,4]. As long as carbon nantube formed on the spiral thread holes in the synthesis process chamber, the current through carbon nanotube has maximum value compared to any other carbon structure, therefore the changing external magnetic field will be compensated if and only if the carbon nanotubes are synthesized. So when carbon nanotube is synthesized, it minimizes the total magnetic power and therefore the total magnetic energy.

Externally the two edges of the processing chamber are connected by an electrical wire to close electrical loop. This wire connection goes through an electrical current gauge. The current gauge works as an indicator of the carbon nanotube synthesis process. The continuously increasing amplitude of the alternative current indicates that carbon nanotube is still in progress, the process has not done yet. The moment when the amplitude of the electrical current becomes saturated (not increases anymore), indicates that the carbon nanotube synthesis has been finished.

Processing sequence:
1. Pump out air between the cylinders.
2. Pump out air from the synthesis chamber.
3. Apply cooling liquid to the cooling pipes.
4. Start rotation of the cylinders together with the cooler, slowly increasing angle speed until it reaches angle speed of the 100 circles/sec. The centrifugal force injects the liquid carbon source (Benzene) in the synthesis chamber and after injection it penetrates to the threaded holes of the external wall of the synthesis chamber.
5. Apply alternating electrical current to the solenoid with a certain frequency which depends on the type of the carbon source used.
6. Watch the amplitude of the current meter. The moment when the current stopped increasing indicates that the carbon nanotube is ready.

The embodiment of this invention presented above is not intended to limit the scope of the invention. Different modifications, alternative parameters or constructions and equivalents may be employed without departing from the true spirit and scope of the appended claims.

### REFERENCES

1. Hoon-Sik Jang, Sang Koo Jeon, Un Bong Back and Seaung Hoon Nahm, Center for materials measurement, Korea Research Institute of Standards and Science, shnahm@kriss.re.kr, “Tensile Properties of Carbon Nanotube with Different Growth Methods”, Proceedings of 10^{th} IEEE International Conference on Nanotechnology Joint Symposium with Nano Korea 2010

2. Wikipedia.org: “Carbon nanotube”

3. Prabhakar R. Bandaru, Department of Mechanical and Aerospace Engineering, Materials Science Program, University of California, San Diego, La Jolla, Calif. 92093-0411, USA, “Electrical Properties and Applications of Carbon Nanotube Structures”, Journal of Nanoscience and Nanotechnology, Vol. 7, 1-29, 2007

4. Charles F. Cornwell, Jeffrey B. Allen, Charles P. Marsh, Thomas A. Carlson, Peter B. Stynoski, Bradley A. Newcomb, Benjamin Masters, Robert M. Ebeling, and Charles R. Welch US Army Engineer Research and Development Center (ERDC), Vicksburg, Miss. {charles.f.cornwell; jeffrey.b.allen; charles.p.marsh; thomas.a.carlson; peter.b.stynoski; bradley.a.newcomb; benjamin.masters; robert.m.ebeling; charles.r.welch}@usace.army.mil “Design of Very High-Strength Aligned and Interconnected Carbon Nanotube Fibers Based on Molecular Dynamics Simulations”, 2010 DoD High Performance Computing Modernization Program Users Group Conference

What is claimed is:

1. An apparatus for synthesizing a single-wall or multi-wall carbon nanotube thread, the technology comprising:
the extracted pure liquid carbon having homogenous structure from the raw liquid carbon source; by using the electro-magnetic resonance to extract pure carbon elements from the homogenous liquid carbon source; the magnetic field is used to synthesize the purified carbon to the honey-comb type crystal carbon nanotube thread with very high tensile[1] and conductivity properties.

2. The apparatus of claim 1, wherein the synthesis chamber is formed by the space between two same centered cylinders but different diameters, rotating with the same angle speed ω.

3. The apparatus of claim 2, wherein the cylinder with a bigger diameter has the spiral threaded holes, which as seen on nut, wrapped around on the internal wall.

4. The apparatus of claim 2, wherein the spiral threaded holes can be manufactured with different sizes therefore synthesized nanotube can be single-wall or multi-wall.

5. The apparatus of claim 1, wherein the rotating synthesis chamber is connected to the container of the raw liquid carbon source through multiple pipes in order to inject the raw liquid carbon source into the synthesis chamber.

6. The apparatus of claim 2, wherein the synthesis chamber and the space between container of the raw liquid carbon source and the synthesis chamber is vacuumed.

7. The apparatus of claim 1, wherein during nanotube synthesis process, constant temperature must be maintained.

8. The apparatus of claim 7, wherein the spiral pipe wrapped around the synthesis chamber bears pre-injected cooling liquid before carbon nanotube synthesis process started.

9. The apparatus of claim 1 and claim 8, wherein the synthesis chamber and cooling pipe are externally driven by a motor and rotate with a desired angle speed.

10. The apparatus of claim 1, wherein the electromagnetic resonance is generated by wires, as known as solenoids, wrapped on a non-rotating cylinder surrounding the synthesis chamber and cooling pipe, therefore the high speed rotating cylinders are isolated from the external world.

11. The apparatus of claim 1 and claim 10, wherein apparatus to generate alternating magnetic field inside of the synthesis chamber.

12. The apparatus of claim 10, wherein the space between non-rotating cylinder and rotating cylinders is vacuumed.

13. The apparatus of claim 11, wherein the frequency of the alternating current depends on the type of the raw liquid carbon source used.

14. The apparatus of claim 1, wherein a wire is connected between two edges of the synthesis chamber through an electrical current gauge.

15. The technology of claim 1, wherein the carbon nanotube synthesis is a self purification process dedicated to reduce defects on nanotube grown.

16. The technology of claim 1, wherein the carbon nanotube synthesis is a process inherently designed to maximize conductivity property of the carbon nanotube.

17. The apparatus of claim 1, wherein the raw liquid carbon source is recommended as Benzene(C6H6), however some other liquid carbon sources can be used as well.
